(19) United States
(12) Patent Application Publication
(10) Pub. No.: US 2006/0036686 A1
(43) Pub. Date: Feb. 16, 2006

(54) Meeting support apparatus and method

(75) Inventor: Nobuhiro Shimogori, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/176,133

(22) Filed: Jul. 8, 2005

(30) Foreign Application Priority Data
Jul. 15, 2004 (JP) P2004-208129

(51) Int. Cl. G06F 15/16

(52) U.S. Cl. 709/204

(57) ABSTRACT

A share data memory stores a plurality of share data each corresponding to a group. The share data is a material for a meeting of a group. A reservation data memory stores a plurality of reservation data each corresponding to a group. The reservation data is schedule data of a group to use the facility. A data acquirement unit acquires share data corresponding to a group from the share data memory based on reservation data corresponding to the group stored in the reservation data memory. A data selection unit presents a list of acquired share data in the facility, and selects at least one data from the list in response to a user's indication. A data output unit outputs the at least one data in the facility.

### CROSS-REFERENCE TO RELATED APPLICATIONS

This application is based upon and claims the benefit of priority from prior Japanese Patent Application No. 2004-208129, filed on Jul. 15, 2004; the entire contents of which are incorporated herein by reference.

### FIELD OF THE INVENTION

The present invention relates to a meeting support apparatus and a method for electronically supporting a meeting of persons by groupware through a network.

### BACKGROUND OF THE INVENTION

By spread of computers, work relating meetings are often executed using an electronic communication means such as e-mail or a bulletin board, and actual meeting of persons is on the decrease. Such system supporting an electronic meeting is called a groupware, and a large number of systems are available. In the groupware, data sharing function such as message exchange and document sharing is provided. Furthermore, in the groupware, a facility management function reserving a meeting room is also provided in order for members to actually hold a meeting. By using this system, preparation of the meeting, adjustment of schedule, reservation of facility (meeting room), and confirmation after the meeting, can be electronically executed through a network. This technique is disclosed in Japanese Patent Disclosure (Kokai) P2002-109444.

Furthermore, an electronic white board system is disclosed in Japanese Patent Disclosure (Kokai) PH11-59072. In this system, an electronic white board apparatus reads information of drawings and writings, and sends the information to a terminal apparatus connected to a LAN (Local Area Network). The information of drawings and writings can be edited and distributed on a PC (Personal Computer).

However, in these systems, connection between an actual meeting of persons and an electronic meeting on network is not taken into consideration. For example, at the beginning of a meeting, it is necessary to print materials for the meeting and distribute the materials to members of the meeting. Furthermore, after the meeting, it is necessary to transfer information described on a white board to groupware. This working is very troublesome for a user.

### SUMMARY OF THE INVENTION

The present invention is directed to a meeting support apparatus and method for easily supplying and saving data necessary for members of a meeting during the actual time of the meeting.

According to an aspect of the present invention, there is provided an apparatus for supporting a meeting in a facility, comprising: a share data memory to store a plurality of share data each corresponding to a group, each share data being a material for a meeting of the group; a reservation data memory to store a plurality of reservation data each corresponding to a group, each reservation data being schedule data of the group to use the facility; a data acquirement unit configured to acquire share data corresponding to a group from said share data memory based on reservation data corresponding to the group stored in said reservation data memory; a data selection unit configured to present a list of acquired share data in the facility, and to select at least one data from the list in response to a user's indication; and a data output unit to output the at least one data in the facility.

According to another aspect of the present invention, there is also provided a method for supporting a meeting in a facility, comprising: storing a plurality of share data each corresponding to a group, each share data being a material for a meeting of a group; storing a plurality of reservation data each corresponding to a group, each reservation data being schedule data of a group to use the facility; acquiring share data corresponding to a group from the plurality of share data based on reservation data corresponding to the group in the plurality of reservation data; presenting a list of acquired share data in the facility; selecting at least one data from the list in response to a user's indication; and outputting the at least one data in the facility.

According to still another aspect of the present invention, there is also provided a computer program product, comprising: a computer readable program code embodied in said product for causing a computer to support a meeting in a facility, said computer readable program code comprising: a first program code to store a plurality of share data each corresponding to a group, each share data being a material for a meeting of a group; a second program code to store a plurality of reservation data each corresponding to a group, each reservation data being schedule data of a group to use the facility; a third program code to acquire share data corresponding to a group from the plurality of share data based on reservation data corresponding to the group in the plurality of reservation data; a fourth program code to present a list of acquired share data in the facility; a fifth program code to select at least one data from the list in response to a user's indication; and a sixth program code to output the at least one data in the facility.

### BRIEF DESCRIPTION OF THE DRAWINGS

FIG. 1 is a block diagram of a meeting support apparatus according to a first embodiment.

FIG. 2 is a schematic diagram of reservation data stored in a reservation data memory 103 according to the first embodiment.

FIG. 3 is a schematic diagram of a data example of a share data list according to the first embodiment.

FIG. 4 is a schematic diagram of one example of a presentation example of a data selection unit 108 according to the first embodiment.

FIG. 5 is a flow chart of registration processing for a meeting room reservation of a facility management unit 102 according to the first embodiment.

FIG. 6 is a flow chart of reply processing for a group name inquiry of the facility management unit 102 according to the first embodiment.

FIG. 7 is a flow chart of processing of a data acquirement unit 104, a data sorting unit 107, a data selection unit 108 and a data supply unit 109 according to the first embodiment.

FIG. 8 is a flow chart of registration processing of a data registration unit 111 according to the first embodiment.

FIG. 9 is a block diagram of the meeting support apparatus according to a second embodiment.

FIG. 10 is a schematic diagram of a group member list stored in a data sharing unit 105 according to the second embodiment.

FIG. 11 is a schematic diagram of an attendance table of group members stored in a reservation data memory 103 according to the second embodiment.

FIG. 12 is a block diagram of the meeting support apparatus according to a third embodiment.

FIG. 13 is a flow chart of processing of the meeting support apparatus according to the third embodiment.

### DETAILED DESCRIPTION OF THE EMBODIMENTS

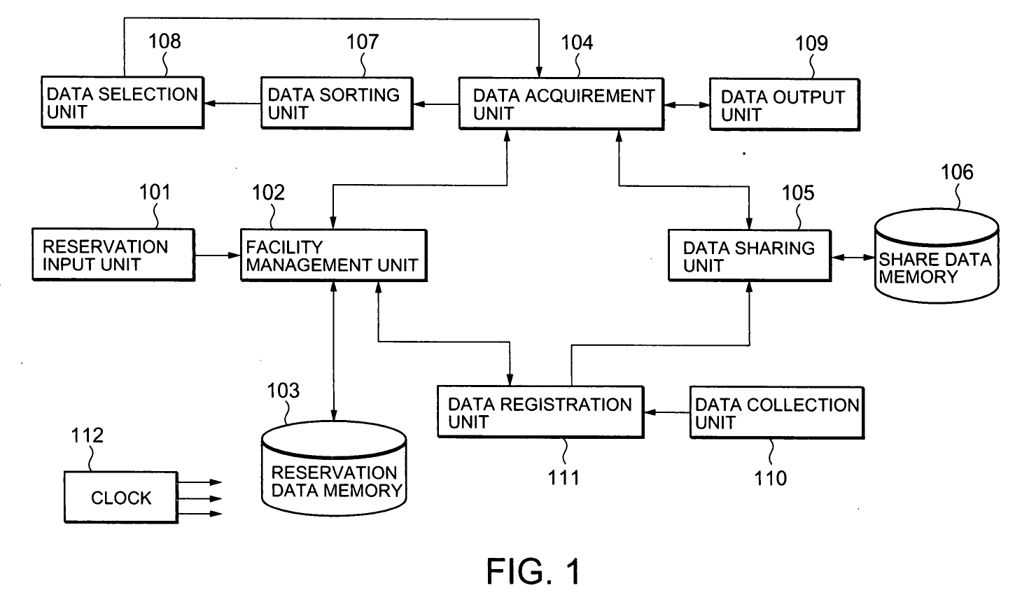

Hereinafter, various embodiments of the present invention will be explained by referring to the drawings. FIG. 1 is a block diagram of a meeting support apparatus according to a first embodiment. In FIG. 1, the meeting support apparatus includes a reservation input unit 101, a facility management unit 102, a reservation data memory 103, a data acquirement unit 104, a data sharing unit 105, a share data memory 106, a data sorting unit 107, a data selection unit 108, a data output unit 109, a data collection unit 110, a data registration unit 111, and a clock 112. For example, the data selection unit 108, the data output unit 109, and the data collection unit 110 are located in a meeting room.

A reservation input unit 101 is an input means for a user (reserver) to reserve a facility, and sends input data (reservation data) to the facility management unit 102. In the first embodiment, the facility is explained as a meeting room. However, the facility may be a place used for a meeting, such as a reception room, a gathering room, or a council room. Furthermore, the meeting includes all situations of discussion with gathered persons, such as arrangement.

The facility management unit 102 receives a meeting room name, a use date, a use time, and a group name. By referring to reservation status of each facility stored in the reservation data memory 103, the facility management unit 102 records reservation data of the meeting room in the reservation data memory 103 if another reservation is not recorded for the same meeting room name at the same date and the same time.

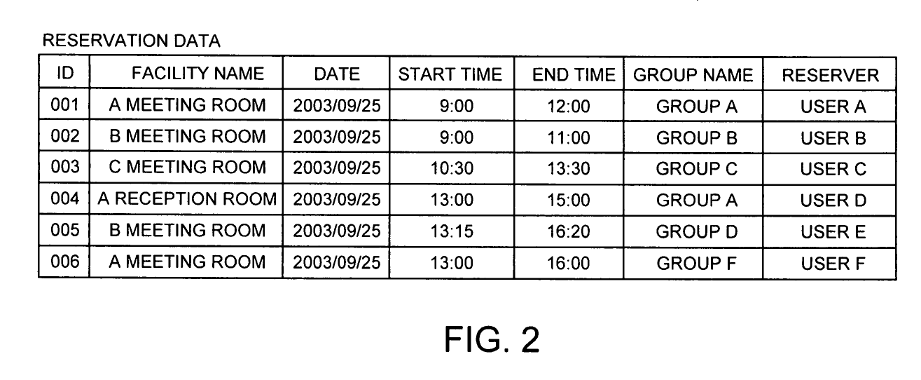

FIG. 2 is one example of reservation data stored in the reservation data memory 103. As shown in FIG. 2, the reservation data comprises a reservation ID, a facility name, a date, a start time, an end time, a group name, and a reserver name.

The data acquirement unit 104 receives reservation data from the reservation data memory 103 through the facility management unit 102. The data acquirement unit 104 extracts a group name (of a group planning to use the meeting room) from the reservation data when a current time coincides with the start time of the date in the reservation data, and sends the group name to the data sharing unit 105. In this case, current time data is obtained from the clock 112.

The data sharing unit 105 receives the group name from the data acquirement unit 104, and sends a share data list of data shared by group members of the group name to the data acquirement unit 104.

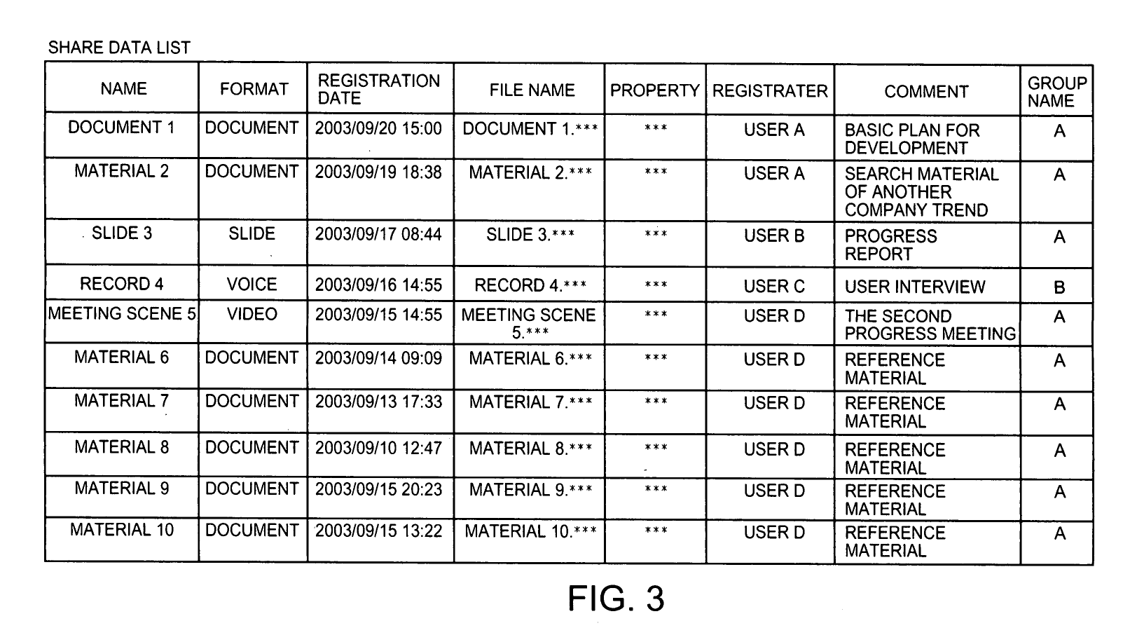

FIG. 3 is one example of the share data list. As shown in FIG. 3, the share data list comprises a name, a format, a registration date, a file name, a property, a registrater, a comment, and a group name.

The “name” represents a title added to share data.

The “format” represents a type of the share data. In this example, a document, a slide, a video, a record, a meeting scene, and a material are set.

The “registration date” represents a date and a time when the share date is registered.

The “file name” represents a file address at which contents of the share data are stored.

The “property” represents a file property of file storing the share data.

The “registrater” represents a user's name who registered the share data.

The “comment” represents an annotation added to the share data. The annotation is input at registration timing.

The “group name” represents a group identifier of a group of which members referred the share data at a meeting.

As a share data list of the present embodiment, an index format to have a look at share data, such as a keyword included in share data or a photograph representing contents of video data, can be used.

Furthermore, as a type of share data of the present embodiment, all electronic data necessary for meeting are regarded as an object. For example, materials of document used for meeting, minutes of previous meeting, an electronic slide used for presentation, a drawing, and a video are used as the type.

The data acquirement unit 104 sends a share data list (received from the data sharing unit 105) to the data sorting unit 107. The data sorting unit 107 sorts (selects) share data of which format is executable by the data output unit 109 from the share data list (received from the data acquirement unit 104). For example, if the data output unit 109 is a printer, share data of which format is “document” is only selected from the share data list. Selection of share data is decided by “file name”, “property” or “format” in the share data list.

Hereinafter, assume that the data output unit 109 is a printer. The data sorting unit 107 selects share data of which format is “document” from the share data list. (In this case, the slide and the video cannot be printed.)

The data selection unit 108 receives a list of selected share data from the data sorting unit 107, presents the list to attendants of a meeting in the meeting room, and urges the attendants to select share data necessary for the meeting.

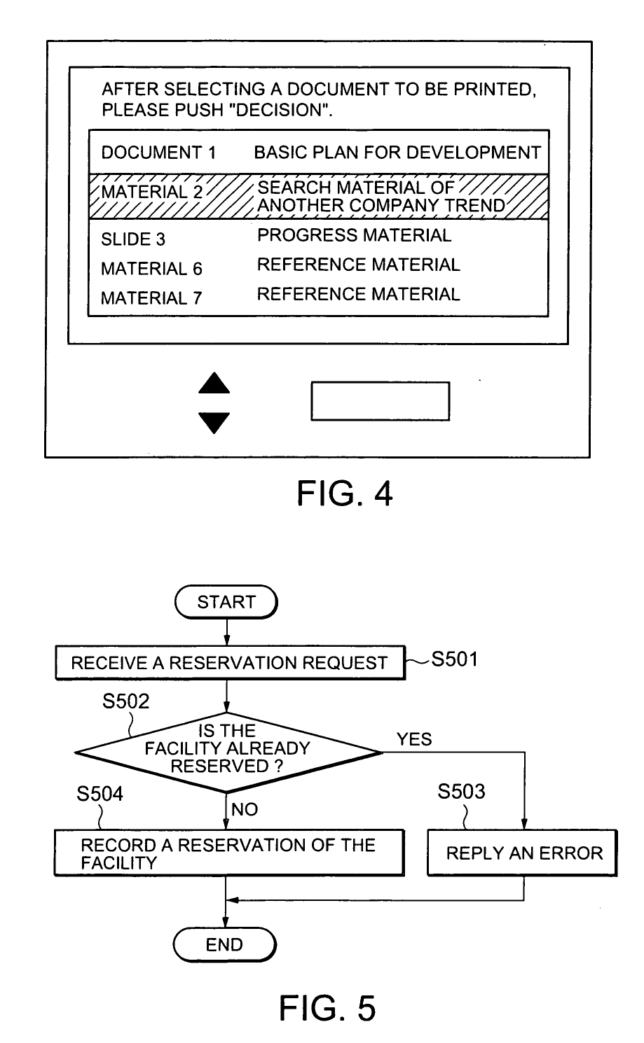

FIG. 4 is one example of presentation screen of the data selection unit 108. In this example, share data of which format is “document” in the share data list of FIG. 3 is only displayed because the data output unit 109 is a printer. When share data necessary for the meeting is selected by an attendant using the data selection unit 108, the data selection unit 108 sends information to obtain contents of selected share data to the data acquirement unit 104. For example, this information is a file name of the selected share data in the share data list presented by the data selection unit 108.

By using the information sent from the data selection unit 108, the data acquirement unit 104 acquires share data (contents) from the share data memory 106 through the data sharing unit 105, and sends the share data (contents) to the data output unit 109.

The data output unit 109 supplies (outputs) the share data to attendants in the meeting room. In this example, the share data is printed on paper. However, the data output unit 109 is not limited to the printer. It may be any device to output information, such as a display, a projector, or a television monitor.

The data collection unit 110 collects (inputs) information generated during the actual meeting, and transfers the information to the data registration unit 111. For example, information mentioned on a white board (with scanner function) is read and the read information is sent. As examples of the data collection unit 110, an image input apparatus of a white board type, a microphone recording a voice, a digital camera recording a photograph, a video camera recording a video, or a text editor recording the proceeding, are used. Briefly, any device to input information can be used.

The data registration unit 111 receives reservation data stored in the reservation data memory 103 through the facility management unit 102, and obtains a group name of the group using the meeting room at the present time. Then, the data registration unit 111 indicates the data sharing unit 105 to store the information (transferred by the data collection unit 110) in the share data memory 106 as share data of the group name.

The data sharing unit 105 receives the information and the group name from the data registration unit 111, and stores the information in the share data memory 106 as the share data in correspondence with the group name.

The data registration unit 111 may store reservation data in correspondence with the share data. For example, the date and the place of the meeting, and a name (white board and so on) of the data collection unit, may be stored in correspondence with the share data in the share data memory 106. In this case, a user (attendant) can know which meeting the share data is collected from.

Next, operation of each unit of the meeting support apparatus is explained. FIG. 5 is a flow chart of registration processing of reservation of meeting room by the facility management unit 102. In FIG. 5, when the facility management unit 102 receives a reservation request from the reservation input unit 101 (S501), the facility management unit 102 checks whether the facility is already reserved at the same date and the same time by referring to the reservation data memory 103 (S502).

If the facility is already reserved (Yes at S502), the facility management unit 102 notifies the user of an error (S503). If the facility is not reserved yet (No at S502), the facility management unit 102 records the data, the time, and the facility name of the reservation request in the reservation data memory 103 (S504), and processing is completed.

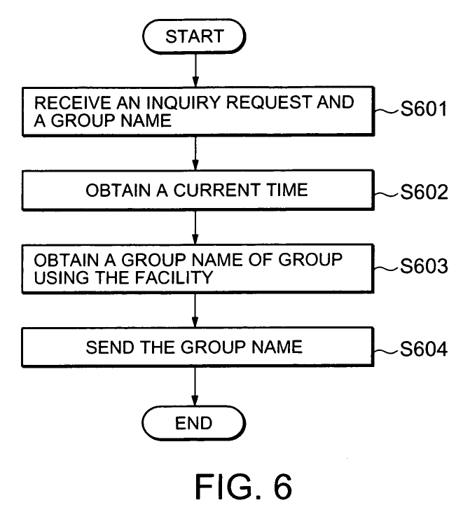

FIG. 6 is a flow chart of reply processing of the facility management unit 102 in response to an inquiry of a group name of a group using the facility from the data acquirement unit 104 (or the data registration unit 111).

When the facility management unit 102 receives an inquiry request and a facility name of an object from the data acquirement unit 102 (or the data registration unit 111) (S601), the facility management unit 102 obtains a current time from the clock (S602), and obtains (retrieves) a group name of a group using the facility from the reservation data memory 103 at the current time (S603). Then, the facility management unit 102 sends the group name to the data acquirement unit 104 (or the data registration unit 111) as an inquiry source (S604), and processing is completed.

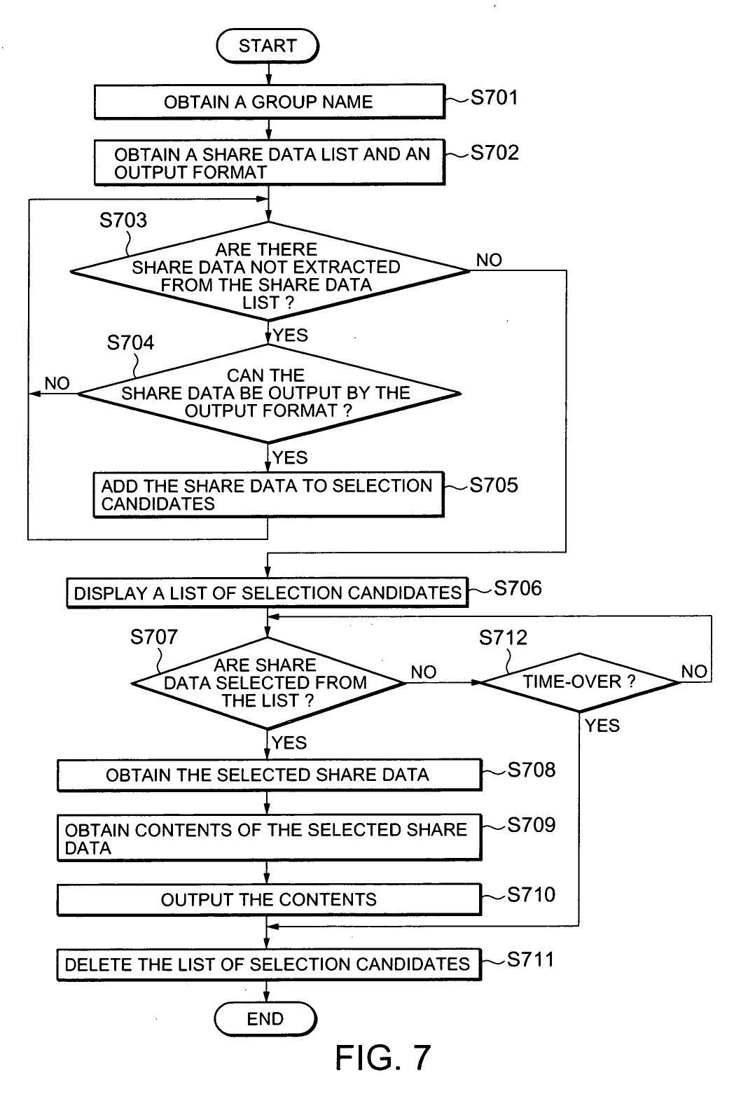

FIG. 7 is a flow chart of processing of the data acquirement unit 104, the data sorting unit 107, the data selection unit 108, and the data output unit 109. In FIG. 7, the data acquirement unit 104 requests a group name of a group using the facility at the present from the facility management unit 102, and obtains the group name (S701).

The data acquirement unit 104 sends the group name to the data acquirement unit 105, and obtains a share data list of the group name from the data sharing unit 105. Then, the data acquirement unit 104 sends the share data list and format data (executable by the data output unit 109) to the data sorting unit 107 (S702). The format data may be detected by the data output unit 109 using a plug and a play function, or may be set to the data acquirement unit 104 by a user.

Next, the data sorting unit 107 decides whether unprocessed share data (share data not extracted yet from the list) exists in the share data list (S703). If the unprocessed share data exists in the share data list (Yes at S703), the data sorting unit 107 extracts the unprocessed share data from the share data list, and decides whether a format of this share data is executable by the data output unit 109 (S704).

If the format of the share data is executable by the data output unit 109 (Yes at S704), the data sorting unit 107 adds this share data to a selection candidate list (S705). On the other hand, if the format of the share data is not executable by the data output unit 109 (No at S704), the data sorting unit 107 extracts the next unprocessed share data from the share data list (S703).

If unprocessed share data does not exist in the share data list (i.e., if all share data in the share data list are processed) (No at S703), the data sorting unit 107 displays the selection candidate list through the data selection unit 108 (S706).

The data acquirement unit 104 periodically monitors input from the data selection unit 108. If at least one share data is selected from the selection candidate list within a predetermined time (Yes at S707), the data acquirement unit 104 receives information of the one share data from the data selection unit 108 (S708), and obtains contents of the one share data from the share data memory 106 through the data sharing unit 105 (S709).

The data acquirement unit 104 outputs the contents of the one share data through the data output unit 109 (S710), deletes the selection candidate list displayed on the data selection unit 108 (S711), and processing is completed.

If any share data is not selected from the selection candidate list within a predetermined time (No at S707 and Yes at S712), the data acquirement unit 104 deletes the selection candidate list displayed on the data selection unit 108 (S711), and processing is completed.

If execution begins from S701 immediately after activating the system and if the above-mentioned processing is repeated until the system is completed, share data of the group using the facility can be supplied to members of the group during the meeting. If a plurality of the above-mentioned processing are prepared, a plurality of data output units 109 of different types can be in one facility.

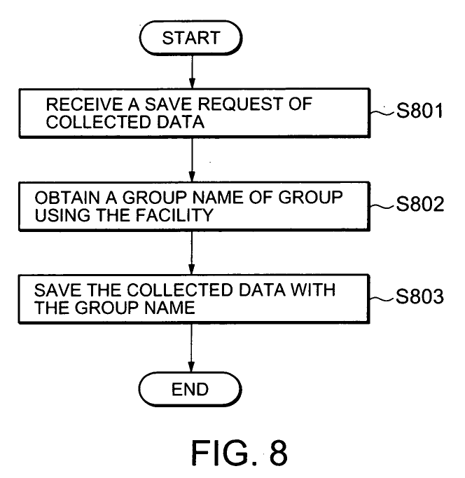

FIG. 8 is a flow chart of processing of the data registration unit 111. In FIG. 8, the data registration unit 111 receives a save request and collected data to be saved from the data collection unit 110 (S801). Furthermore, the data registration unit 111 obtains a group name of a group using the facility from the facility management unit 102 (S802). Next, the data registration unit 111 sends the group name and the collected data to the data sharing unit 105, and instructs the data sharing unit 105 to save the collected data as share data of the group name. When the collected data is stored in correspondence with the group name in the share data memory 106 (S803), processing is completed.

As mentioned-above, in the first embodiment, at a reservation time of a facility by a group, the meeting support system is automatically connected to the facility reserved by the group. Accordingly, acquirement of data necessary for a meeting of the group and saving of data generated from the meeting can be easily executed without troublesome operation.

Next, the meeting support apparatus of the second embodiment is explained by referring to the drawings. In the first embodiment, for example, if another meeting scheduled prior a user's meeting is held over the user's schedule time in the same facility, materials related to the user's meeting could be presented to attendants of another meeting not related to the user. Accordingly, in the second embodiment, an authentication unit is added in order to authenticate each attendant of a meeting in the facility at the start time of the meeting. Furthermore, materials (share data) generated during the meeting are sent to absentees of the meeting.

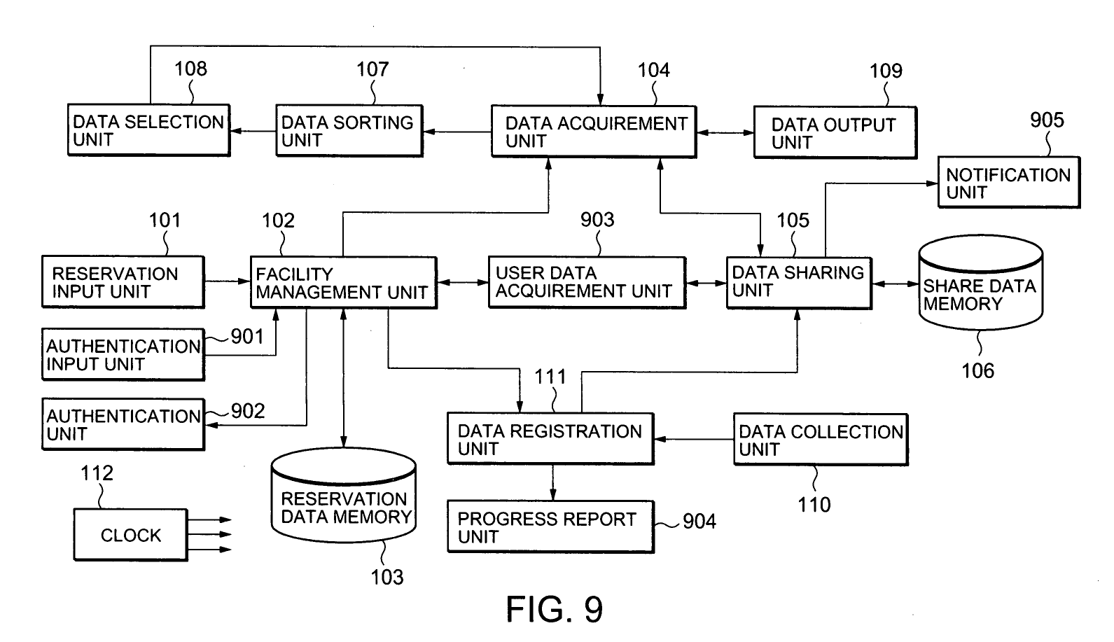

FIG. 9 is a block diagram of the meeting support apparatus according to the second embodiment. As for same units as the first embodiment, the same numbers are added and explanation of the processing is omitted.

In FIG. 9, in comparison with FIG. 1, an authentication input unit 901 to input information for authenticity of attendants, an authentication unit 902 to execute authentication processing, a user data acquirement unit 903 to acquire user data (For example, a group member list), a progress report unit 904 to send a progress of collected data to absentees in real time, and a notification unit 905 to notify each member of the collected data based on presence and absence of each member are added. For example, the data selection unit 108, the data output unit 109, the data collection unit 110, the authentication input unit 901, the progress report unit 904, and the notification unit 905 are located in a meeting room.

Next, operation of the meeting support apparatus of the second embodiment is explained. At the beginning of the meeting, each attendant inputs information necessary for authentication from the authentication input unit 901. As for the information necessary for authentication, notification of ID (identifier) by an ID card, log-in system by a user name and a password, or authentication by physical feature (such as a face, a fingerprint, or a voice), can be used. In the second embodiment, in order to simplify the explanation, the log-in system by a user name and a password is used. The authentication unit 902 previously stores a user name and a password corresponding to the user name.

First, when the authentication input unit 901 inputs information (In this example, the user name and the password) necessary for authentication for each attendant of a meeting, the facility management unit 102 checks whether an attendance table of members of a group of the meeting is already generated. If the attendance table is not generated yet, the facility management unit 102 generates the attendance table of the meeting. In order to generate the attendance table, the facility management unit 102 sends the group name of the meeting to the user data acquirement unit 903. The user data acquirement unit 903 acquires a group member list of the group name from the data sharing unit 105, and sends the group member list to the facility management unit 105. After receiving the group member list, the facility management unit generates an attendance table by setting all members as absentees in the group member list.

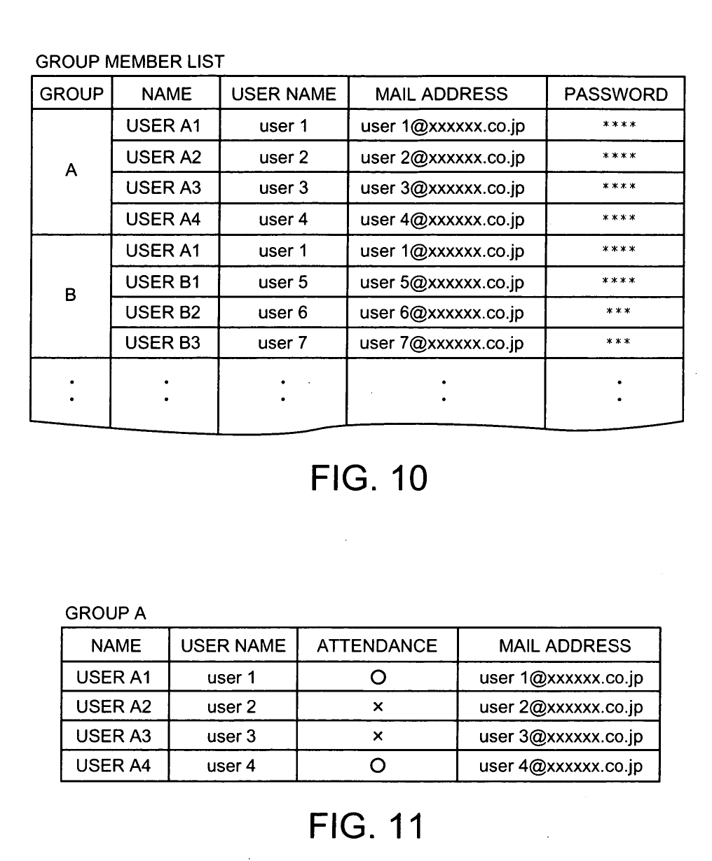

In this case, the data sharing unit 105 previously stores a group member list. FIG. 10 is one example of the group member list. As shown in FIG. 10, a member name, a user name (user code), a mail address, and a password are stored in correspondence with each group name (group identifier). At the time when collected data is stored first in correspondence with a group name in the share data memory 106, the data sharing unit 105 generates a group member list comprising the group name and member names, and stores the group member list. Hereinafter, in response to a request of group member list with a group name from the user data acquirement unit 903, the data sharing unit 105 extracts a group member list corresponding to the group name, and replies with the group member list to the user data acquirement unit 903.

FIG. 11 is one example of an attendance table of members of a group of the meeting stored in the reservation data memory 103. First, the facility management unit 102 checks whether a user name input by the authentication input unit 901 is registered in the attendance table. If the user name is not registered in the attendance table, the authentication input unit 901 notifies the user of an error. If the user name is registered in the attendance table, the authentication input unit 901 sends the user name and the passwords to the authentication unit 902 in order to authenticate the user.

If a pair of the user name and the passwords coincides with the registered pair, authenticity of the user succeeds. In this case, the user is recorded as present in the attendance table. Furthermore, a user flag of the facility is changed as “using” and the data acquirement unit 104 is activated.

Next, the data collection unit 110 periodically collects data generated from the actual meeting, and sends the data to the data registration unit 111. The data registration unit 111 obtains absentee information from the facility management unit 102, and sends the collected data to a mail address of each absentee stored in the attendance table of FIG. 11. Accordingly, the absentee can know a progress of the meeting. The collected data may be sent to the absentee after the meeting.

When the data collection unit 110 requests from the data registration unit 111 of data saved after the meeting, the data registration unit 111 obtains a group name of the meeting from the facility management unit 102 and the attendance table from the reservation data memory 103. The data registration unit 111 sends these data to the data sharing unit 105.

The data sharing unit 105 stores data (collected by the data collection unit 110) as share data of the group name in the share data memory 106, and instructs the notification unit 905 to differently notify the attendant and the absentee of the share data based on the attendance table. For example, an electronic mail informing that new share data is stored in the share data memory 106 is sent to the absentee only.

As mentioned-above, in the second embodiment, by generating an attendance table of members of the meeting and authenticating each attendant, attendants of the meeting are correctly checked. Furthermore, by periodically sending data collected from the meeting to each absentee, absentees can know the progress of the meeting.

Next, the meeting support apparatus of the third embodiment is explained by referring to the drawings. In the third embodiment, even if persons hold a meeting on condition that a facility (meeting room) is not reserved, the persons can indicate one of existing groups stored in the data sharing unit 105 or create a new group in the data sharing unit 105. In both cases, the persons can save collected data of the meeting as share data of the group in the share data memory 106.

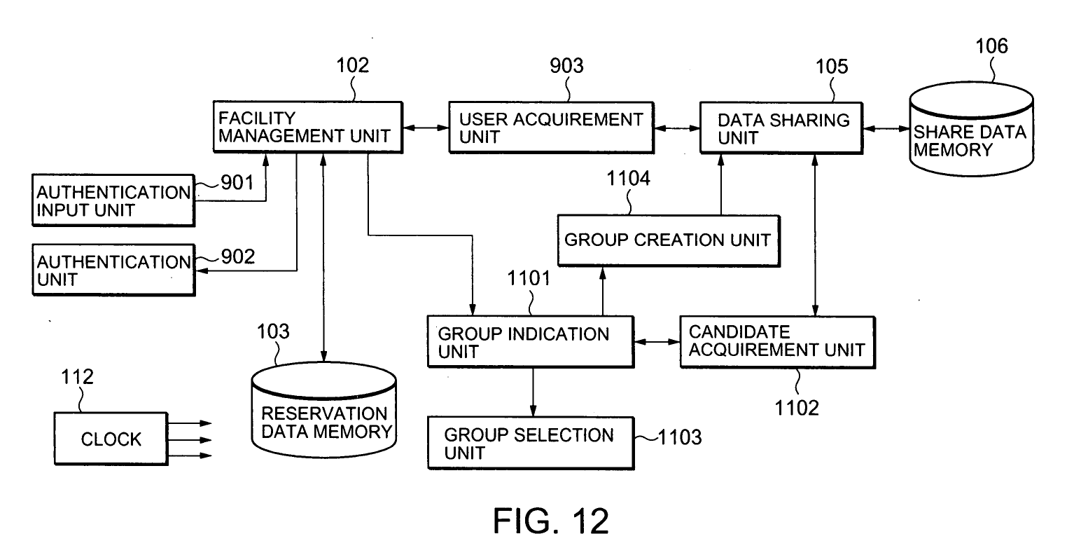

FIG. 12 is a block diagram of the meeting support apparatus according to the third embodiment. As for the same units in the first and second embodiments, the same numbers are assigned and an explanation of processing is omitted.

In FIG. 12, in comparison with FIG. 1, a group indication unit 1101, a candidate acquirement unit 1102, a group selection unit 1103, and a group creation unit 1104 are added.

Units 101˜111 and units 901˜903 are the same as in the second embodiment. For example, the authentication input unit 901 and the group selection unit 1103 are located in a meeting room. When a facility is used without reservation, the facility management unit 102 creates an attendance table of which member names are empty. The authentication unit 902 authenticates each attendant using a user name and a password input from the authentication input unit 901. If an attendant is authenticated, the authentication unit 902 enters the user name of the attendant into the attendance table. In this example, presence and attendance are decided by input of the user name and the password. However, authenticity is also necessary to enter a meeting room. If a user name and a password are input at the user's entrance of the meeting room, an entrance key of the meeting room may be used as authenticity of presence and absence by authenticity at the user's entrance of the meeting room. In this case, it is not necessary for the attendant to authenticate two times.

After activating the group indication unit 1101, the group indication unit 1101 requests a list of attendants from the facility management unit 102. Furthermore, the group indication unit 1101 sends the list of attendants to the candidate acquirement unit 1102 based on the attendance table.

In response to the list of attendants, the candidate acquirement unit 1102 obtains a list of groups in which the attendants participated in the past from the data sharing unit 105, and sends the list of groups to the group indication unit 1101. The group indication unit 1101 displays the list of groups as selection candidates through the group selection unit 1103 in order to urge the attendants to select. Furthermore, the group selection unit 1103 displays a text box to register a new group name. When a group name is input into the text box and a decision button is selected by an attendant, the new group name is added.

When one group is selected from the list of groups by the attendant, the group indication unit 1101 sends a group name of the one group to the facility management unit 102. The facility management unit 102 registers the group name as a group using the facility in the reservation data memory 103. On the other hand, when a new group name is input to the text box (displayed on the group selection unit 1103) by the user, the group indication unit 1101 sends a new group creation signal (an instruction to register a group name, the new group name input to the text box, and attendants names as members of the group) to the group creation unit 1104.

The group creation unit 1104 indicates the data sharing unit 105 to create a new group, and registers the attendants names as members of the new group in the data sharing unit 105.

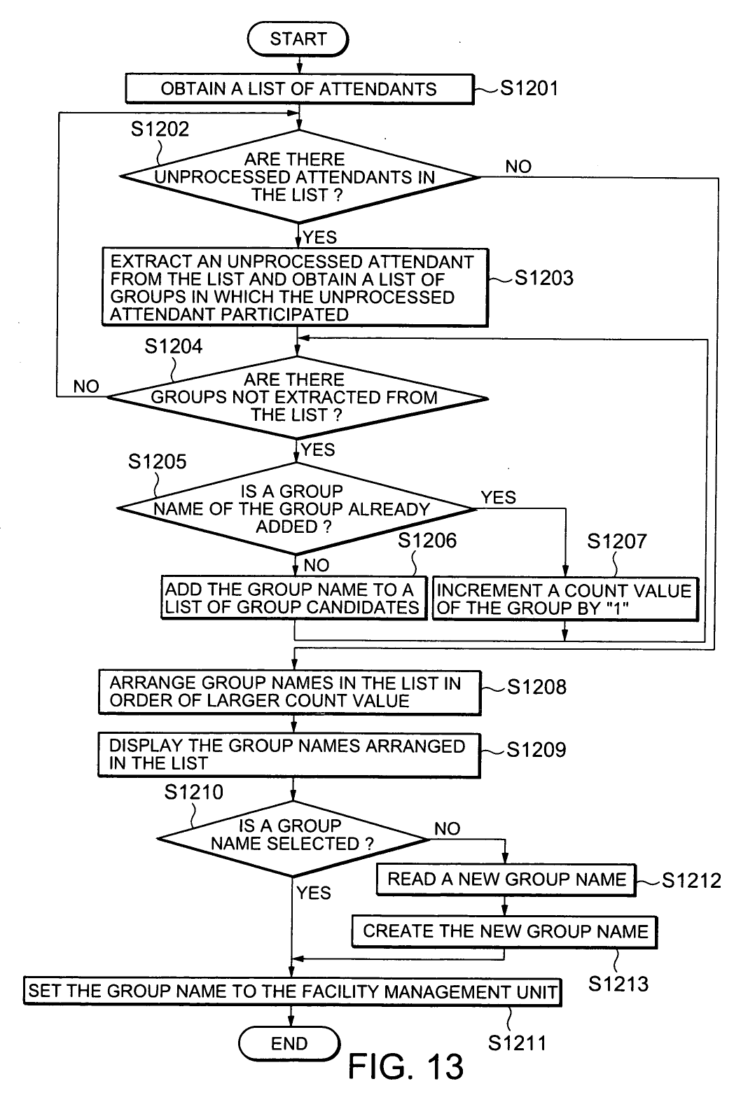

FIG. 13 is a flow chart of processing of the meeting support apparatus according to the third embodiment. First, by activating the meeting support apparatus, the group indication unit 1101 obtains a list of attendants from the facility management unit 102 (S1201). If at least one unprocessed attendant (an attendant name not extracted from the list) exists in the list of attendants (Yes at S1202), a name of the one unprocessed attendant is extracted from the list, and group names in which the one unprocessed attendant participated in the past are extracted from the group member list of the data sharing unit 105 (S1203). At first processing of step S1202, all attendants on the list are not processed yet (not extracted from the list). Accordingly, first execution result of step S1202 is “Yes”.

As for a list of the group names in which the one unprocessed attendant participated in the past, one group name is extracted from the list, and decided whether the one-group name is already added to a list of group candidates (selection groups) (S1205). At first processing of step S1204 for each attendant name, processing of the list of candidates (S1205˜S1207) is not executed at all. Accordingly, first execution result of step S1204 is “Yes”.

If the group name is already added to the list of candidates (Yes at S1205), a count value of the Group name is incremented by “1” (S1207). If the group name is not added to the list of candidates yet (No at S1205), the group name is added to the list of candidates (S1206), and a count value of the group name is incremented by “1” (S1207). In both cases, this processing is executed for all group names in the list of groups in which the same attendant participated in the past (S1204).

If all group names are already extracted (all group names are already processed) from the list of group names (No at S1204), the next unprocessed attendant is extracted from a list of attendants (S1202), and the same processing is executed for the next unprocessed attendant.

If all attendants in the list of attendants are already processed (No at S1202), group names in the list of candidates are arranged in order of larger count value (S1208). The list of candidates in which group names are arranged is displayed through the group selection unit 1103 in order to urge the user to select (S1209). At step S1209, a new group name may be created by the user's inputting the new group name to the text box.

In response to the user's input at step S1209, it is decided whether the user selects one group name from the list of candidates displayed (S1210). If the user selects one group name from the list of candidates (Yes at S1210), the one group name is registered in the facility management unit 102 (S1211), and processing is completed.

On the other hand, if the user inputs a new group name to the text box (No at S1210), the new group name (input in the text box by GUI) is read (S1212), and the new group name and the list of attendants are sent to the group creation unit 1104 in order to create new group. These processing are executed by the group indication unit 1101.

Next, in response to the new group name and the list of attendants from the group indication unit 1101, the group creation unit 1104 creates a new group of which members are the attendants of the list and its group name is the new group name in the data sharing unit 105 (S1213).

Next to step S1213, the group indication unit 1101 registers the new group name in the facility management unit 102 (S1211), and processing is completed.

As mentioned-above, in the third embodiment, even if persons hold a meeting on condition that a group is not registered, data sharing memory space to store information of the group is newly created during the meeting, and record (collected information) of the meeting is saved in the data sharing space. Accordingly, the meeting support apparatus for easily sharing data among members of the new group can be provided.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for supporting a meeting in a facility, comprising:
a share data memory to store a plurality of share data each corresponding to a group, each share data being a material for a meeting of a group;
a reservation data memory to store a plurality of reservation data each corresponding to a group, each reservation data being schedule data of a group to use the facility;
a data acquirement unit configured to acquire share data corresponding to a group from said share data memory based on reservation data corresponding to the group stored in said reservation data memory;
a data selection unit configured to present a list of acquired share data in the facility, and to select at least one data from the list in response to a user's indication; and
a data output unit to output the at least one data in the facility.

2. The apparatus according to claim 1,
wherein each share data includes a data name, a format, a registration date, a file name, a property, a registrater name, a comment, and a group name.

3. The apparatus according to claim 2,
wherein each reservation data includes an identifier, a facility name, a date, a start time, an end time, a group name, and a reservater name.

4. The apparatus according to claim 1,
further comprising a reservation input unit to receive a reservation request of the facility, the reservation request including a date, a start time, an end time, and a group name.

5. The apparatus according to claim 4,
further comprising a facility management unit configured to decide whether the facility is already reserved at the date and the time by referring to said reservation data memory in response to the reservation request from said reservation input unit, and to record reservation data of the facility at the date and the time in said reservation data memory if the facility is not reserved yet.

6. The apparatus according to claim 5,
further comprising a clock, and
wherein said facility management unit searches reservation data of which schedule time coincides with a current time of the clock from said reservation data memory, and sends a group name included in the reservation data to said data acquirement unit.

7. The apparatus according to claim 6,
wherein said data acquirement unit acquires share data corresponding to the group name from said share data memory.

8. The apparatus according to claim 7,
wherein said data selection unit previously selects share data of which format can be processed by said data output unit from acquired share data, and creates the list of selected share data.

9. The apparatus according to claim 1,
further comprising a data collection unit configured to electronically collect data generated by attendants of the meeting in the facility.

10. The apparatus according to claim 9,
further comprising a data sharing unit configured to obtain a group name of the attendants in response to an attendant's save request, and to save collected data as share data corresponding to the group name in said share data memory.

11. The apparatus according to claim 10, further comprising
an authentication input unit to input authentication data of each attendant of the meeting in the facility, and
an authentication unit configured to decide authenticity of each attendant using the authentication data.

12. The apparatus according to claim 11,
wherein said data sharing unit creates a group member list at the first time of the meeting, the group member list including a group name and member names each of which authenticity is properly decided.

13. The apparatus according to claim 12,
wherein, when the group member list is already stored, said data sharing unit creates an attendance table of members of the group by using the group member list and the authenticity of each attendant.

14. The apparatus according to claim 13,
further comprising a notification unit configured to electronically notify each member of the collected data based on presence and absence of each member of the attendance table.

15. The apparatus according to claim 13,
further comprising a progress report unit configured to periodically send a progress of the collected data to absent members in the attendance table.

16. The apparatus according to claim 13,
wherein, when the facility is used by attendants of the meeting without reservation, said data sharing unit retrieves group names to which each attendant belongs from the group member list, and creates a group candidates list including the group names.

17. The apparatus according to claim 16,
further comprising a group selection unit configured to present the group candidates list, and to select one group name from the group candidate list in response to an attendant's indication.

18. The apparatus according to claim 18,
wherein said data sharing unit creates an access area for the attendants in correspondence with the one group name in said share data memory.

19. A method for supporting a meeting in a facility, comprising:
storing a plurality of share data each corresponding to a group, each share data being a material for a meeting of a group;
storing a plurality of reservation data each corresponding to a group, each reservation data being schedule data of a group to use the facility;
acquiring share data corresponding to a group from the plurality of share data based on reservation data corresponding to the group in the plurality of reservation data;
presenting a list of acquired share data in the facility;
selecting at least one data from the list in response to a user's indication; and
outputting the at least one data in the facility.

20. A computer program product, comprising:
a computer readable program code embodied in said product for causing a computer to support a meeting in a facility, said computer readable program code comprising:
a first program code to store a plurality of share data each corresponding to a group, each share data being a material for a meeting of a group;
a second program code to store a plurality of reservation data each corresponding to a group, each reservation data being schedule data of a group to use the facility;
a third program code to acquire share data corresponding to a group from the plurality of share data based on reservation data corresponding to the group in the plurality of reservation data;
a fourth program code to present a list of acquired share data in the facility;
a fifth program code to select at least one data from the list in response to a user's indication; and
a sixth program code to output the at least one data in the facility.
